(19) United States
(12) Patent Application Publication
(10) Pub. No.: US 2010/0113103 A1
(43) Pub. Date: May 6, 2010

(54) COMMUNICATION APPARATUS WITH INCOMING CALL PROMPT

(75) Inventors: Teh-Shen Lee, Tu-Cheng (TW); Chiung-Li Chang, Tu-Cheng (TW)

Correspondence Address: PCE INDUSTRY, INC.;ATT. Steven Reiss, 288 SOUTH MAYO AVENUE, CITY OF INDUSTRY, CA, 91789, US

(73) Assignee: HON HAI PRECISION INDUSTRY CO., LTD., Tu-Cheng (TW)

(21) Appl. No.: 12/344,580

(22) Filed: Dec. 28, 2008

(30) Foreign Application Priority Data
Nov. 5, 2008 (CN) 200820302648.4

(51) Int. Cl. H04B 1/38

(52) U.S. Cl. 455/567

(57) ABSTRACT

A communication apparatus with incoming call prompt is provided. The communication apparatus includes an input unit, a receiver, an indicator light, a memory, and a processor. The processor connected with the indicator light and the memory, is configured for controlling the indicator light to emit corresponding colored light as a prompt.

### TECHNICAL FIELD

The disclosure relates to a communication apparatus with incoming call prompt.

### DESCRIPTION OF RELATED ART

Communication apparatuses such as mobile phones play an important role in people's life and are a necessary part of daily life. Generally, when there is an incoming call or message, a phone is set to play a melody, however, in hospitals, offices, libraries etc., the melody prompt may be unwelcome and intrusive. Of course, the phone can be set to a vibration mode, but the vibration prompt is easy to miss if you are not near your phone.

a communication apparatus that uses a light as a prompt seems to resolve the problems described above, for example, when there is an incoming call, a light on the phone can flash, but the light prompt cannot impart other information, such as a caller name, to the user other than alerting the user to an incoming call or message. Therefore, what is needed is a communication apparatus with an incoming call prompt which can overcome the aforementioned shortcomings.

### BRIEF DESCRIPTION OF THE DRAWINGS

The components of the drawings are not necessarily drawn to scale, the emphasis instead being placed upon clearly illustrating the principles of communication apparatus. Moreover, in the drawings, like reference numerals designate corresponding parts throughout several views.

FIG. 1 is a block diagram of a communication apparatus in accordance with an exemplary embodiment.

FIG. 2 is a portable phone with an indicator light in accordance with an exemplary embodiment.

FIG. 3 is an exemplary schematic diagram illustrating a incoming call prompt table with an exemplary embodiment.

### DETAILED DESCRIPTION OF EMBODIMENTS

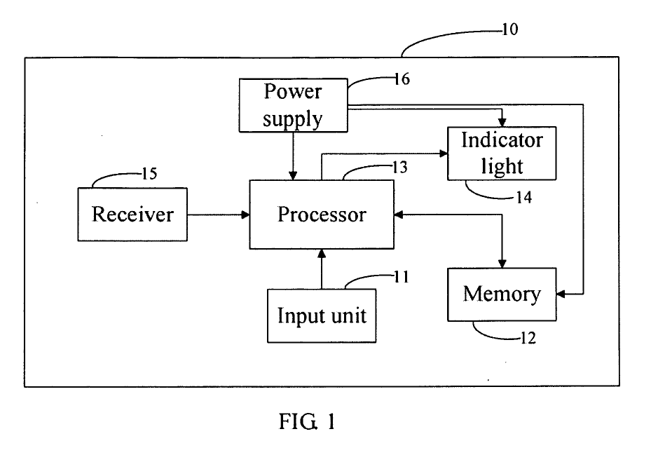

FIG. 1 is a block diagram of a hardware infrastructure of a communication apparatus in accordance with an exemplary embodiment. The communication apparatus includes at least one input unit 11, a memory 12, a processor 13, an indicator light 14, a receiver 15, and a power supply 16.

The input unit 11 is configured for receiving user input.

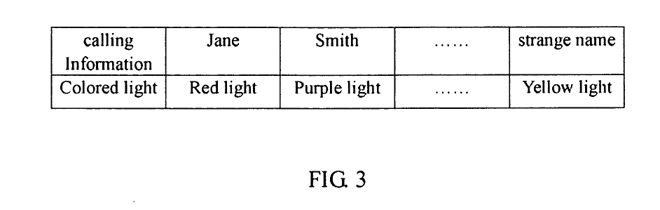

The memory 12 is configured for storing an incoming call prompt table (see FIG. 3), wherein the incoming call prompt table can be defined by a user manually. The incoming call prompt table includes, in this embodiment, a row for incoming caller and a row for associating a caller name with a specific color of light. The incoming call information may instead be or include, but is not limited to, incoming call phone number, area or region from which the incoming call is made, and so on. For example, as shown in FIG. 3, incoming calls from caller named Jane as programmed by user is associated with a red light as a prompt, incoming calls from John Smith are associated with a purple light, and incoming calls from unknown callers are associated with a yellow light and means caller ID of the incoming call has not been associated with a colored light. In another exemplary embodiment, calls could be associated with different colored lights according to region from which the call originated. For example, Detroit may be associated with a yellow light.

The receiver 15 is configured for receiving the incoming call.

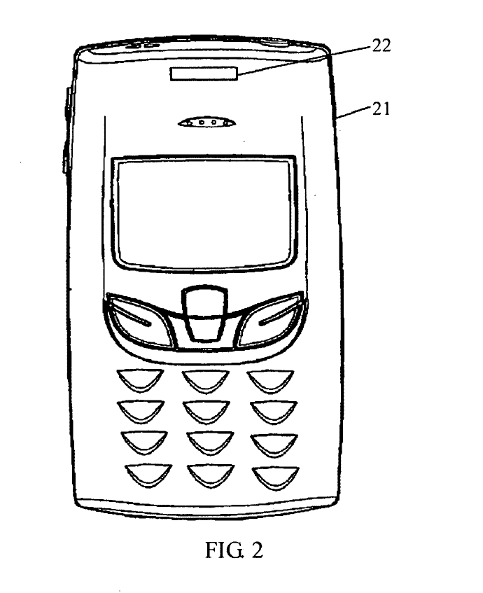

The indicator light 14 is configured for emitting different colored lights. The indicator light 14 is installed in a visible place in the communication apparatus. For example, in the exemplary embodiment as shown in FIG. 2, an indicator light 22 is installed in the front of the portable phone 21.

The power supply 16 is configured for supplying electrical power to all elements of the communication apparatus.

The processor 13 is connected with the input unit 11, the indicator light 14, the receiver 15, and the power supply 16. The processor 13 is configured for controlling the indicator light 14 to emit corresponding colored light according to the incoming call prompt table and the incoming call. In the exemplary embodiment, when the incoming call is from Smith, the processor 13 controls the indicator light 14 to emit purple light as a prompt according to the table in FIG. 3, and when the incoming call is from an unknown caller, the processor 13 controls the indicator light 14 to emit yellow light. In the exemplary embodiment as shown in FIG. 2, the portable phone 21 is taken as the communication apparatus, and when there is an incoming call, the processor 13 controls the indicator light 22 to emit corresponding colored light according to the incoming call prompt table.

Although the present invention has been specifically described on the basis of the exemplary embodiment thereof, the invention is not to be construed as being limited thereto. Various changes or modifications may be made to the embodiment without departing from the scope and spirit of the invention.

1. A communication apparatus with incoming call prompt, comprising:
an input unit for receiving user input;
a receiver for receiving incoming call;
an indicator light for emitting different colored lights;
a memory for storing an incoming call table, wherein the table associates incoming call information with different colored lights, and the incoming call information in the incoming call table includes at least incoming caller; and
a processor connected with the indicator light, the input unit, the receiver and the memory, and configured for controlling the indicator light to emit corresponding colored light according to the incoming call table and at least the incoming caller.

2. The communication apparatus as described in claim 1, wherein the incoming call table is defined by a user manually.

3. The communication apparatus as described in claim 1, wherein the incoming call information in the incoming call table further includes at least incoming call phone number, area or region from which the incoming call is made.

4. The communication apparatus as described in claim 1, wherein the incoming call table records a predetermined colored light to represent the incoming calls from an unknown caller.

5. The communication apparatus as described in claim 4, wherein the unknown caller is a caller ID of the incoming call has not been previously associated with a colored light.
